(19) United States
(12) Patent Application Publication
(10) Pub. No.: US 2007/0239935 A1
(43) Pub. Date: Oct. 11, 2007

(54) Digital storage device

(75) Inventor: Chien-Yuan Chen, Banchiau City (TW)

Correspondence Address: TROXELL LAW OFFICE PLLC;SUITE 1404, 5205 LEESBURG PIKE, FALLS CHURCH, VA, 22041, US

(73) Assignee: Power Data Communications Co., Ltd. & Chien-Yuan CHEN

(21) Appl. No.: 11/315,366

(22) Filed: Dec. 23, 2005

(51) Int. Cl. G06F 12/00

(52) U.S. Cl. 711/115

(57) ABSTRACT

A digital storage device includes primarily a multi-memory card interface and a USB interface integrated into a common bus which is complied with the specification of a USB junction. A connection circuit between the common bus and a flash memory is formed by a related switch circuit, so as to constitute a digital storage device which is provided with a transmission function for a plurality of memories, and can perform a signal access with a USB transmission interface or a multi-memory card transmission interface including an SD transmission interface, an MMC transmission interface, an MS PRO transmission interface, an XD transmission interface, an SM transmission interface, and a CF transmission interface of an electronic device, by interconnecting with a corresponding connection port through the single common bus.

### BACKGROUND OF THE INVENTION

(a) Field of the Invention

The present invention relates to a digital storage device and more particularly to a kind of digital storage device which can perform data access with a USB (Universal Serial Bus) transmission interface or a multi-memory card transmission interface of an electronic device by interconnecting to a corresponding connection port through a single common bus.

(b) Description of the Prior Art As the market of small size digital equipment such as a digital camera, a camcorder, an MP3 player, a mobile phone, etc., is getting more and more prosperous, its interior key elements will be directly affected. To correspond with a miniaturization and sophistication of these kinds of products, the development of technology of key elements is also toward miniaturization and chip design, and the circuit board used for configuring these mini IC (Integrated Circuit) elements is also getting smaller and smaller, while its density is getting higher and higher.

Accordingly, a digital storage device such as the memory card (e.g., Smart Media Card, Secure Digital Card, Multi Media Card, Memory Stick Card, Compact Flash Card, extreme Digital Picture card, etc.) or the personal disk used for storing video clips, digital pictures, MP3 music and game data for the aforementioned small size digital equipment has become the personal belonging of many computer users. Comparing to a disk, the memory card and personal disk are smaller in size, whereas they have a much larger capacity and a faster access speed. Moreover, these two storage devices are not easily got wet or damaged like the disks, thereby allowing many consumers to replace the disks with these two storage devices for carrying.

Referring to FIG. 1, as a transmission interface used for connecting a personal disk A is not the same as that used for connecting a memory card B on a circuit board E; for example, the transmission interface for the personal disk A is a USB junction 100, whereas the transmission interface for the memory card B is a conduction terminal 200 which is called the golden finger; therefore, the circuit board E should be installed with two interfaces corresponding to the USB connection port C and the memory card connector D respectively, which is rather inconvenient in application.

Moreover, a relationship of connection on schematic diagrams and requirements in circuit engineering (such as the high frequency characteristics, the impedance of elements, the anti-jamming, etc.) should be taken into consideration in the circuit layout on circuit board E. On the other hand, installation holes, plugs, positioning holes, and all kinds of elements should be accurately installed on specified positions, in order to facilitate an installation of peripheral equipment and maintain a good effect of ventilation and heat dissipation. In addition, the layout of terminal pad, through-hole, routing, etc., will affect a quality of reliability, and should also assure that the elements will not collide with each other and can be installed, tuned, and repaired conveniently.

In other words, the miniaturization of digital equipment is primarily dependent upon the installation of internal IC elements and circuit board layout which will be getting more complicated as the increase of functions. However, due to a limitation of narrowness of circuit layout, it is impossible to add more IC elements and wiring layout. Assembling more elements will also cause a drawback that the digital equipment will be enlarged.

Accordingly, if the elements on a substrate I of circuit board can be integrated, such as by simplifying the transmission interface (e.g., a USB connection port, a memory card connector) connected to its peripheral equipment, a single interface can be adapted to interfaces of various specifications in a narrow circuit layout, then the following positive effects can be achieved:
(1) It can save a process of assembling and can also reduce a cost of manufacturing.
(2) It can reduce a space to be occupied and can enable a miniaturization design for an electronic product.
(3) A single interface can be adapted to various transmission interfaces, thereby having a convenience in application.

### SUMMARY OF THE INVENTION

Accordingly, the present invention is to integrate a multi-memory card interface and a USB interface into a common bus which conforms to the specification of a USB junction. In addition, a connection circuit between this common bus and a flash memory is formed by a related switch circuit and a control chip, so as to constitute a digital storage device which is provided with a transmission function for a plurality of memories, and can perform a signal access with a USB transmission interface or a multi-memory card transmission interface including an SD (Secure Digital Card) transmission interface, an MMC (Multi Media Card) transmission interface, an MS PRO (Memory Stick PRO Card) transmission interface, an XD (eXtreme Digital Picture Card) transmission interface, an SM (Smart Media Card) transmission interface, and a CF (Compact Flash Card) transmission interface of an electronic device by interconnecting to a corresponding connection port through the single common bus.

Upon implementing, the entire common bus is provided with a first circuit contact block and at least a second circuit contact block, wherein the configuration of circuit junctions in the first contact block is complied with the corresponding pattern of USB connection port, which is primarily used to enable the digital storage device to perform a data transmission with an interconnected electronic device through the USB transmission interface; and some circuit junctions in the second contact block are provided with a specified configuration pattern and are primarily connected with the circuit junctions in the first contact block, which are used to enable the digital storage device to perform the data transmission with the interconnected electronic device through the multi-memory card transmission interface.

Accordingly, only a single common bus is required for the digital storage device itself, and a function of a portion of circuit junctions in the common bus is shared between the multi-memory card interface and the USB interface; therefore, it will not increase a size of digital storage device and increase an inconvenience in application. Correspondingly, only a connection port corresponding to the common bus is required to be installed on the electronic device applied with the digital storage device, then a data transmission with the digital storage device can be performed through the USB transmission interface or the multi-memory card transmission interface, thereby achieving the objects of saving a space of circuit board, simplifying a layout and assembling of the circuit board, increasing an overall reliability, and reducing inventory and cost of logistics.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional personal disk and a memory card in a status of usage.

FIG. 2 shows a block diagram of an implementation of the present invention.

FIG. 3 shows a structural diagram of a substrate of the present invention.

FIG. 4 shows a schematic view of configuration status of a first and a second contact block of the present invention.

FIG. 5 shows a schematic view of configuration status of a first and a second contact block of another implementation of the present invention.

FIG. 6 shows a circuit diagram of an implementation of the present invention.

FIG. 7 shows a structural diagram of an implementation of a digital storage device of the present invention.

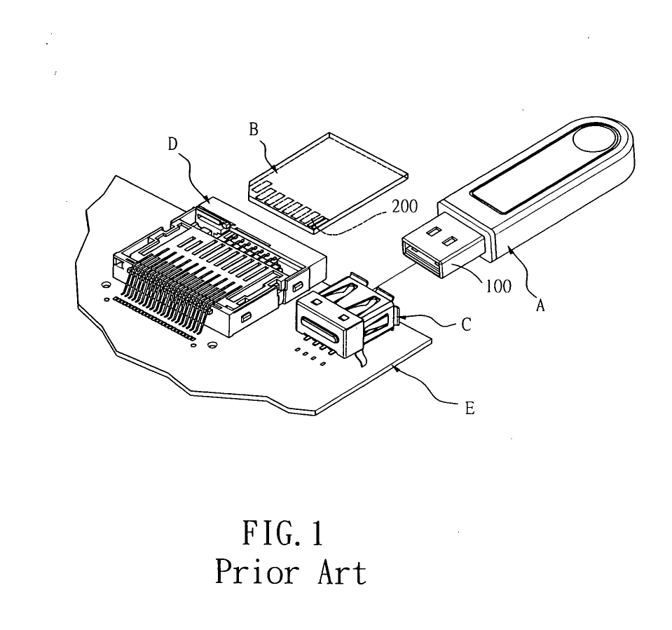

### DETAILED DESCRIPTION OF THE PREFERRED EMBODIMENTS

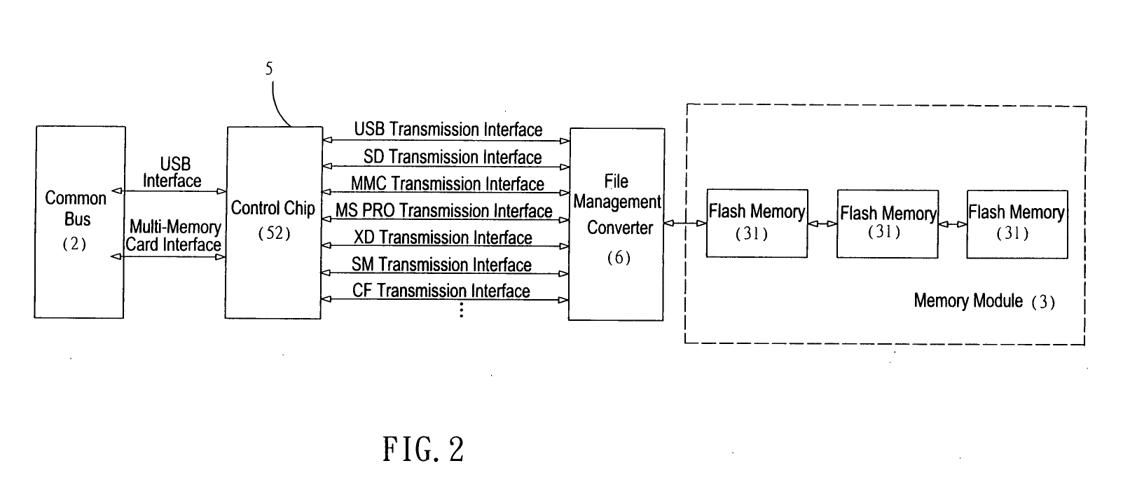

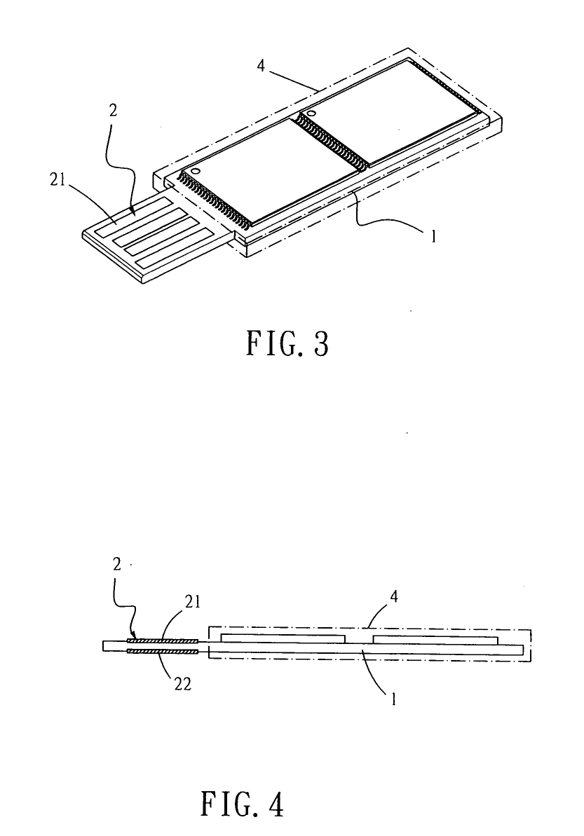

Referring to FIG. 2, which shows a block diagram of an implementation of the present invention, and FIG. 3 and FIG. 4, a digital storage device comprises a substrate 1 which is provided with a common bus 2, a linking wiring, and IC elements including a related control chip, a switch circuit, and a memory module. A layer of casing 4 is wrapped on an exterior of the substrate 1 with only the common bus 2 being exposed at an end of the substrate 1, so as to constitute a necessary shielding to the IC elements on the substrate 1.

The common bus 2 is provided with a first circuit contact block 21 and at least a second circuit contact block 22, wherein the configuration of circuit junctions in the first contact block 21 is complied with the corresponding pattern of USB connection port, which is primarily used to enable the digital storage device to perform a data transmission with an inter connected electronic device through the USB transmission interface; and some circuit junctions in the second contact block 22 are provided with a specified configuration pattern and are primarily connected with the circuit junctions in the first contact block 21, which are used to enable the digital storage device to perform the data transmission with the interconnected electronic device through the multi-memory card transmission interface.

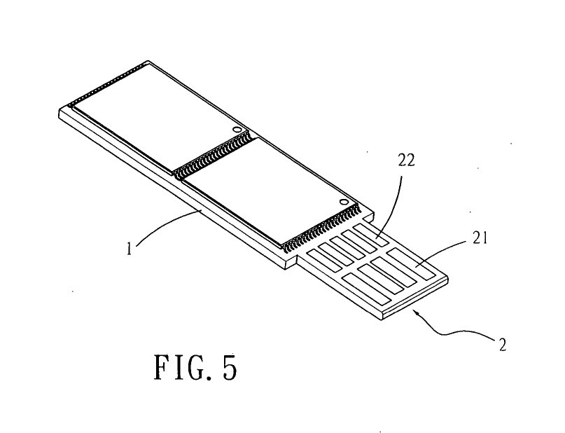

Upon implementing, the first contact block 21 and the second contact block 22 can be installed on an upper and lower board surface of the substrate 1 respectively, as shown in FIG. 4, or can be installed on a front and a rear section of a same board surface of the substrate respectively, as shown FIG. 5, thereby being integrated into the same common bus 2. Therefore, only the single common bus 2 is required to be installed in the whole digital storage device, and a function of a portion of circuit junctions (circuit junctions of the first contact block 21 are shown in the drawings) is shared between the multi-memory card interface and the USB interface, which will not increase a size of the digital storage device and increase an inconvenience in application.

Correspondingly, only a connection port corresponding to the common bus 2 is required to be installed on the electronic device applied with the digital storage device, then a data transmission with the digital storage device can be performed through the USB transmission interface or the multi-memory card transmission interface, thereby achieving the objects of saving a space of circuit board, simplifying a layout and assembling of the circuit board, increasing an overall reliability, and reducing inventory and cost of logistics.

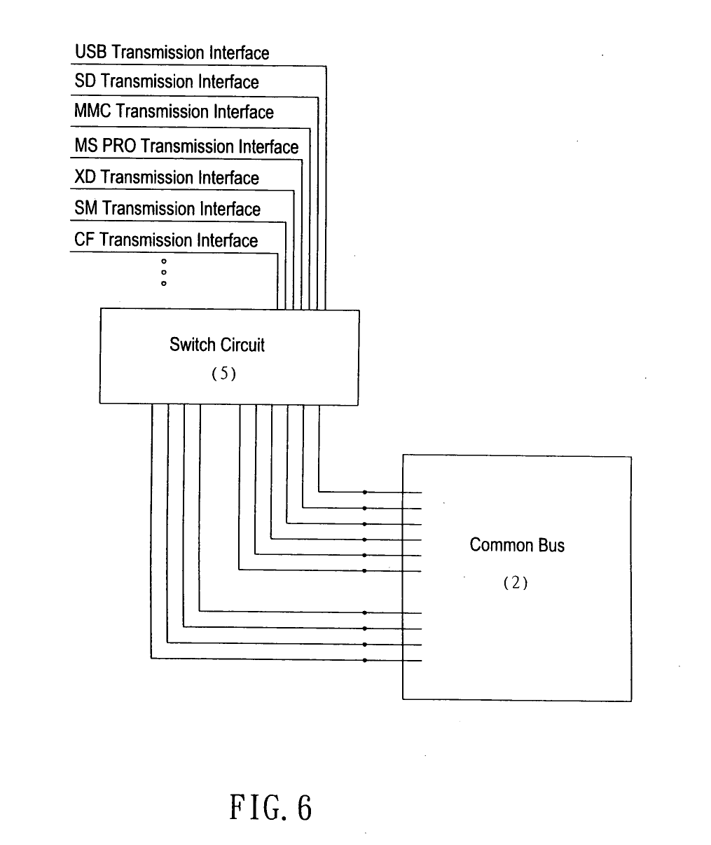

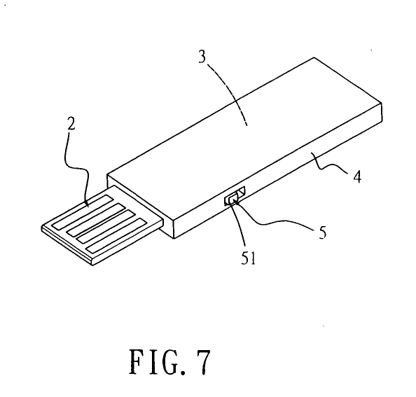

Moreover, as shown in FIG. 6, a switch circuit 5 is used in the present invention to control the digital storage device to use the USB interface or the multi-memory card interface in the common bus 2 to perform a data access with a flash memory in the memory module. Upon implementing, the switch circuit 5 can switch between the USB interface and the multi-memory card interface with a manual mode of a switch 51, as shown in FIG. 7, or can perform an automatic switching between the USB interface and the multi-memory card interface with an installation of a control chip 52, and more particularly a multi-interface control chip, as shown in FIG. 2, so as to achieve an automatic switch between the USB interface and the multi-memory card interface.

In addition, a file management converter 6 is further installed to constitute a circuit linking between the switch circuit 5 and the memory module 3 in corresponding to the differences in transmission modes between various kinds of memory card transmission interfaces, such that data can be converted to a specified flash memory 31 of the memory module 3 or can be output from the flash memory 31 through the file management converter 6. As this kind of switching technique is well known, it will not be described further.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A digital storage device comprising a multi-memory card interface and a USB interface being integrated into a common bus which conforms to the specification of a USB junction so as to constitute a digital storage device which is provided with a transmission function for a plurality of memories and can perform a signal access with a USB transmission interface or a multi-memory transmission interface including an SD transmission interface, an MMC transmission interface, an MS PRO transmission interface, an XD transmission interface, an SM transmission interface, and a CF transmission interface of an electronic device by interconnecting with a corresponding connection port through the single common bus.

2. The digital storage device according to claim 1, wherein the common bus is provided with a first contact block, and at least a second contact block, wherein the configuration of circuit junctions in the first contact block conforms to the corresponding pattern of USB connection port, and some circuit junctions in the second contact block are provided with a specified configuration pattern.

3. The digital storage device according to claim 2, wherein some circuit junctions in the second contact block are connected with the circuit junctions in the first contact block, so as to enable the digital storage device to perform a data transmission with an interconnected electronic device through the multi-memory card transmission interface.

4. The digital storage device according to claim 1, wherein the first and second contact blocks are located at an upper and a lower board surface of a substrate, respectively.

5. The digital storage device according to claim 1, wherein the first and second contact blocks are located at a front and a rear position of a same board surface of a substrate, respectively.

6. The digital storage device according to claim 1, wherein a switch circuit is used to constitute a circuit linking between the common bus and a memory module.

7. The digital storage device according to claim 6, wherein the switch circuit can switch between the USB interface and the multi-memory card interface through a manual mode of a switch.

8. The digital storage device according to claim 6, wherein the switch circuit can perform an automatic switching between the USB interface and the multi-memory card interface with an installation of a control chip.

9. The digital storage device according to claim 8, wherein the control chip is a multi-interface control chip.

10. The digital storage device according to claim 1, wherein a switch circuit and a file management converter are used to constitute a circuit linking between the common bus and a memory module.
